(19) United States
(12) Patent Application Publication
(10) Pub. No.: US 2025/0047043 A1
(43) Pub. Date: Feb. 6, 2025

(54) SHIELD CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Masanao SHIROTA, Osaka (JP); Toshifumi ICHIO, Osaka (JP); Masanao YAMASHITA, Osaka (JP); Toshikazu SUZUKI, Osaka (JP)

(21) Appl. No.: 18/718,144

(22) PCT Filed: Oct. 31, 2022
(86) PCT No.: PCT/JP2022/040643

§ 371 Date: Jun. 10, 2024

(30) Foreign Application Priority Data
Dec. 15, 2021 (JP) 2021-203102

(51) Int. Cl. H01R 13/6582; H01R 13/6474

(52) U.S. Cl. CPC H01R 13/6582; H01R 13/6474

(57) ABSTRACT

A shield connector includes an inner conductor shaped by bending an elongated metal plate material in a plate thickness direction and including a first connecting portion and a second connecting portion extending from a bent portion in directions different from each other, a dielectric to be mounted with the inner conductor, and an outer conductor for surrounding the dielectric. The dielectric includes a first terminal accommodating portion for surrounding and accommodating the first connecting portion over an entire periphery and a second terminal accommodating portion for accommodating the second connecting portion. The first terminal accommodating portion includes a body member integrally molded with the second terminal accommodating portion and a cover member to be assembled with the body member in a direction intersecting a longitudinal direction of the first connecting portion.

### TECHNICAL FIELD

The present disclosure relates to a shield connector.

### BACKGROUND

Patent Document 1 discloses a shield connector provided with an inner conductor terminal having a bent shape and a dielectric for accommodating the inner conductor terminal. The inner conductor terminal is inserted into the dielectric by pushing a bent portion of the inner conductor terminal. The inner conductor terminal is formed by stamping a metal plate material into an L shape. A pressing force is applied to the bent portion in a direction perpendicular to a plate thickness direction of the inner conductor terminal. Therefore, when the pressing force is applied to the bent portion, there is no possibility that the inner conductor terminal is deformed.

### PRIOR ART DOCUMENT

### Patent Document

Patent Document 1: JP 2008-146878 A

### SUMMARY OF THE INVENTION

### Problems to be Solved

If the inner conductor terminal is formed by bending a flat plate member made of metal in the plate thickness direction, the pressing direction is the same direction as the plate thickness direction. Thus, the inner conductor terminal may be deformed by a pressing force applied to the bent portion. As a countermeasure against this, it is thought to form a narrow portion by cutting both side edge parts in a width direction of the inner conductor terminal into a rectangular shape and press a step portion on the front end of the narrow portion. However, in this case, an impedance mismatch occurs between a region of the inner conductor terminal where the narrow portion is formed and regions other than the narrow portion in the inner conductor terminal and there is a concern that communication performance is reduced.

A shield connector of the present disclosure was completed on the basis of the above situation and aims to suppress an impedance mismatch.

### Means to Solve the Problem

The present disclosure is directed to a shield connector with an inner conductor shaped by bending an elongated metal plate material in a plate thickness direction, the inner conductor including a first connecting portion and a second connecting portion extending from a bent portion in directions different from each other, a dielectric to be mounted with the inner conductor, and an outer conductor for surrounding the dielectric, the dielectric including a first terminal accommodating portion for surrounding and accommodating the first connecting portion over an entire periphery and a second terminal accommodating portion for accommodating the second connecting portion, and the first terminal accommodating portion including a body member integrally molded with the second terminal accommodating portion and a cover member to be assembled with the body member in a direction intersecting a longitudinal direction of the first connecting portion.

### Effect of the Invention

According to the present disclosure, an impedance mismatch can be suppressed.

### BRIEF DESCRIPTION OF THE DRAWINGS

FIG. 1 is a perspective view of a shield connector of a first embodiment in an assembled state.

FIG. 2 is an exploded perspective view of the shield connector.

FIG. 3 is a perspective view of a large-size dielectric and large-size inner conductors in a disassembled state.

FIG. 4 is a perspective view of a small-size dielectric and small-size inner conductors in a disassembled state.

FIG. 5 is a back view of the shield connector in the assembled state.

FIG. 6 is a bottom view of the shield connector in the assembled state.

FIG. 7 is a section along A-A of FIG. 5.

FIG. 8 is a plan view showing a state where the large-size inner conductors are assembled with a large-size body member.

FIG. 9 is a graph showing characteristic impedances of the large-size inner conductor of the first embodiment and an inner conductor to be compared.

FIG. 10 is an exploded perspective view of a shield connector of a second embodiment.

FIG. 11 is a perspective view of a large-size dielectric and large-size inner conductors in a disassembled state.

FIG. 12 is a perspective view of a small-size dielectric and small-size inner conductors in a disassembled state.

FIG. 13 is a back view of the shield connector in the assembled state.

FIG. 14 is a bottom view of the shield connector in the assembled state.

FIG. 15 is a section along B-B of FIG. 13.

FIG. 16 is a plan view showing a state where the large-size inner conductors are assembled with a large-size body member.

### DETAILED DESCRIPTION TO EXECUTE THE INVENTION

### Description of Embodiments of Present Disclosure

First, embodiments of the present disclosure are listed and described.

(1) The shield connector of the present disclosure is provided with an inner conductor shaped by bending an elongated metal plate material in a plate thickness direction, the inner conductor including a first connecting portion and a second connecting portion extending from a bent portion in directions different from each other, a dielectric to be mounted with the inner conductor, and an outer conductor for surrounding the dielectric, the dielectric including a first terminal accommodating portion for surrounding and accommodating the first connecting portion over an entire periphery and a second terminal accommodating portion for accommodating the second connecting portion, and the first terminal accommodating portion including a body member integrally molded with the second terminal accommodating portion and a cover member to be assembled with the body member in a direction intersecting a longitudinal direction of the first connecting portion. According to the configuration of the present disclosure, in assembling the inner conductor with the dielectric, the first connecting portion can be accommodated into the first terminal accommodating portion without pressing the inner conductor in the plate thickness direction. It is not necessary to form a step portion for pressing the inner conductor in the plate thickness direction at the bent portion or in a part near the bent portion in the inner conductor. Therefore, a region of the inner conductor where the first connecting portion, the bent portion and the second connecting portion are connected can be set to have a constant width. In this way, an impedance mismatch in the bent portion of the inner conductor can be suppressed.

(2) Preferably, the first terminal accommodating portion and the first connecting portion are formed with a holding portion for restricting a relative displacement of the first connecting portion in the longitudinal direction of the first connecting portion with respect to the first terminal accommodating portion. According to this configuration, the first connecting portion can be reliably held in the first terminal accommodating portion by the holding portion.

(3) Preferably in (2), the holding portion includes a cut portion shaped by cutting a side edge part of the first connecting portion and a fitting portion formed in the first terminal accommodating portion, the cut portion being fit to the fitting portion. According to this configuration, the inner conductor can be held positioned with respect to the dielectric by the locking action of the cut portion and the fitting portion.

(4) Preferably in (2) or (3), the holding portion includes a lock hole formed in the first connecting portion and a locking protrusion formed in the first terminal accommodating portion, the locking protrusion being accommodated into the lock hole. According to this configuration, the inner conductor can be held positioned with respect to the dielectric by the locking action of the lock hole and the locking protrusion.

(5) Preferably in (4), the lock holes include a circular positioning lock hole and an elliptical tolerance absorbing lock hole spaced apart in the longitudinal direction of the first connecting portion, one locking protrusion, out of two circular locking protrusions, is fit into the positioning lock hole with relative displacements in two-dimensional directions restricted, and the other locking protrusion, out of the two circular locking protrusions, is fit into the tolerance absorbing lock hole with a relative displacement in one direction restricted. According to this configuration, even if an interval between the two locking protrusions varies, such a variation can be absorbed by the tolerance absorbing lock hole.

(6) Preferably, the body member is formed with an accommodation groove open in a direction opposite to an extending direction of the second connecting portion, the accommodation groove accommodating the first connecting portion, and the second terminal accommodating portion is formed with a positioning portion for positioning an extending end part of the second connecting portion. According to this configuration, in the process of accommodating the first connecting portion into the accommodation groove, the extending end part of the second connecting portion can be positioned by the positioning portion.

(7) Preferably in (6), the positioning portion is in the shape of a hole for allowing passage of the extending end part of the second connecting portion therethrough. According to this configuration, the extending end part of the second connecting portion can be positioned in two-dimensional directions.

(8) Preferably, the first and second connecting portions extend in directions at an obtuse angle to each other. According to this configuration, when the positions of the extending end of the first connecting portion and that of the second connecting portion are fixed, the entire length of the inner conductor can be shortened as compared to the case where the first and second connecting portions extend in directions at a right angle to each other. Further, in the bent portion of the inner conductor, an impedance is lower than in the both connecting portions. However, since the bent portion connects the both connecting portions at an obtuse angle, an impedance reduction is suppressed as compared to the case where the both connecting portions are connected at a right angle. In this way, an impedance mismatch between the both connecting portions and the bent portion can be suppressed to be small.

(9) Preferably in (8), the second terminal accommodating portion is in the form of a groove extending along a longitudinal direction of the second connecting portion and open in a direction opposite to an extending direction of the first connecting portion. According to this configuration, even if the second terminal accommodating portion is not constituted by two members, the second connecting portion can be accommodated into the second terminal accommodating portion in the process of assembling the first connecting portion with the body member while moving the first connecting portion in the plate thickness direction.

### Details of Embodiments of Present Disclosure

### First Embodiment

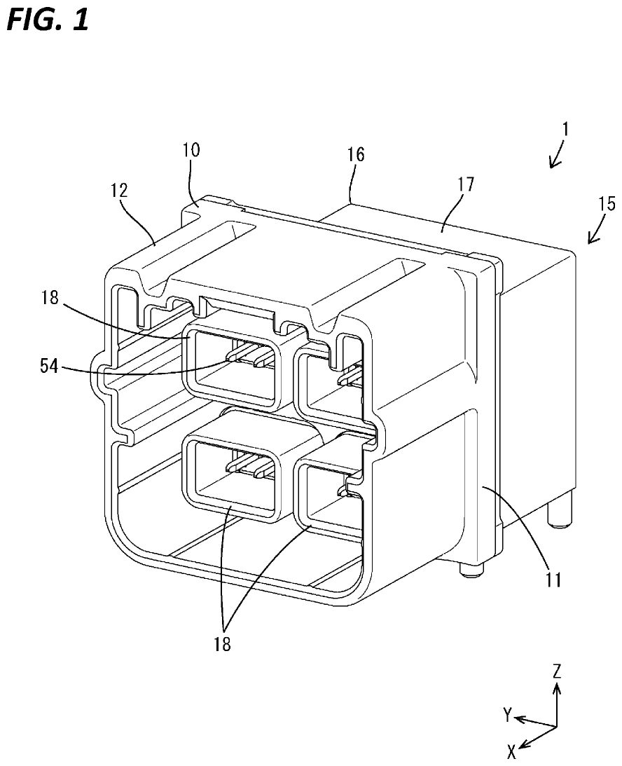

A first specific embodiment of the present disclosure is described with reference to FIGS. 1 to 9. Note that the present invention is not limited to these illustrations, but is represented by claims and intended to include all changes in the scope of claims and in the meaning and scope of equivalents. In the first embodiment, a positive direction along an X axis in FIGS. 1 to 4 and 6 to 8 is defined as a forward direction concerning a front-rear direction. A positive direction along a Y axis in FIGS. 1 to 6 and 8 is defined as a rightward direction concerning a lateral direction. A positive direction along a Z axis in FIGS. 1 to 5 and 7 is defined as an upward direction concerning a vertical direction.

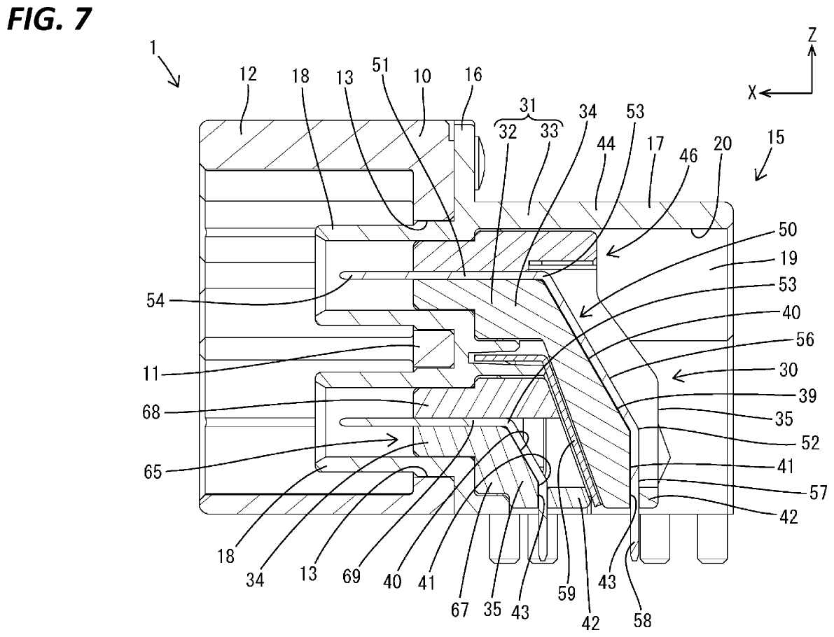

As shown in FIG. 1, a shield connector 1 of the first embodiment is configured by assembling one receptacle member 10 and one shield terminal 15. As shown in FIGS. 1 and 7, the receptacle member 10 is a single component including a base portion 11 and a tubular connecting portion 12. The base portion 11 is in the form of a wall having a thickness direction oriented in the front-rear direction. The base portion 11 is formed with four through holes 13 aligned in the vertical and lateral directions. The tubular connecting portion 12 is in the form of a rectangular tube projecting forward from the outer peripheral edge of the base portion 11.

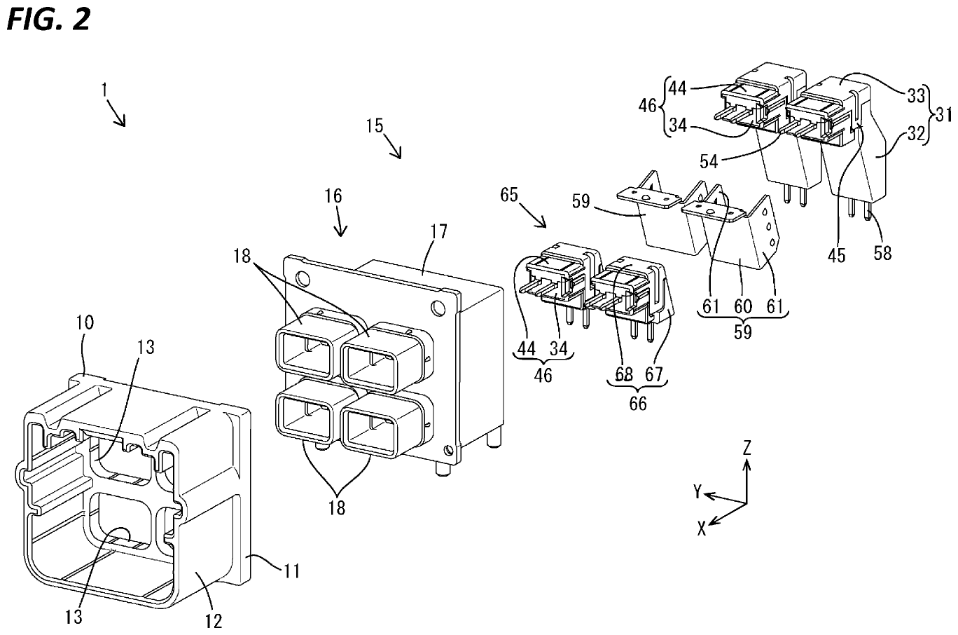

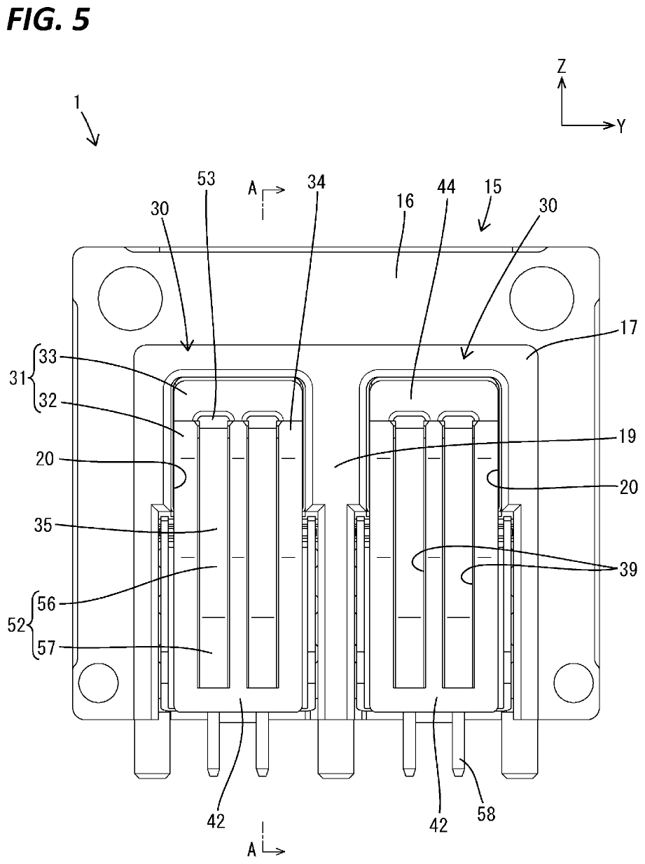

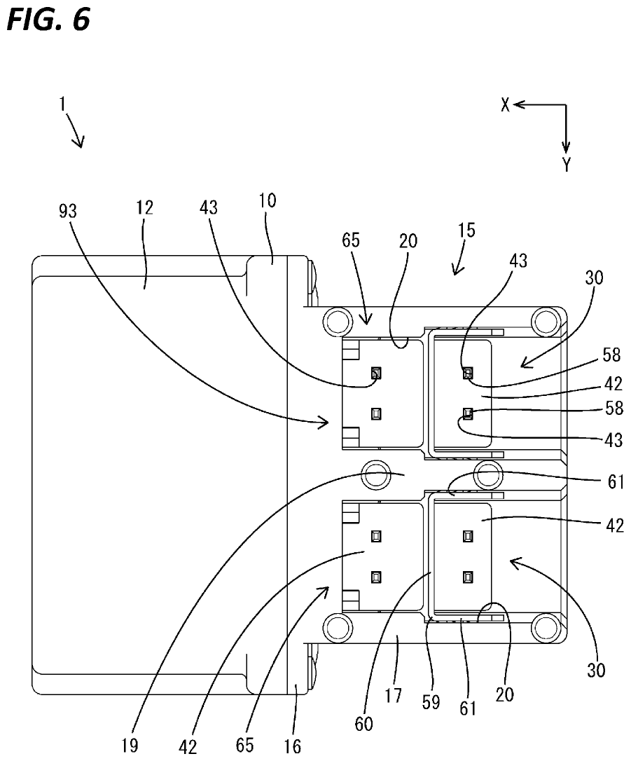

As shown in FIG. 2, the shield terminal 15 is configured by assembling one outer conductor 16, a pair of large-size terminal modules 30 arranged in the lateral direction and a pair of small-size terminal modules 65 arranged in the lateral direction. The outer conductor 16 is a single component made of die casting. The outer conductor 16 includes a box-shaped body portion 17 with open rear and lower surfaces and four connection ports 18 in the form of rectangular tubes projecting forward from the box-shaped body portion 17. As shown in FIGS. 5 and 6, the inside of the box-shaped body portion 17 is partitioned into two left and right accommodation spaces 20 by a partition wall 19. The four connection ports 18 are aligned and arranged in the vertical and lateral directions. The connection ports 18 communicate with the accommodation spaces 20.

### (Large-Size Terminal Module 30)

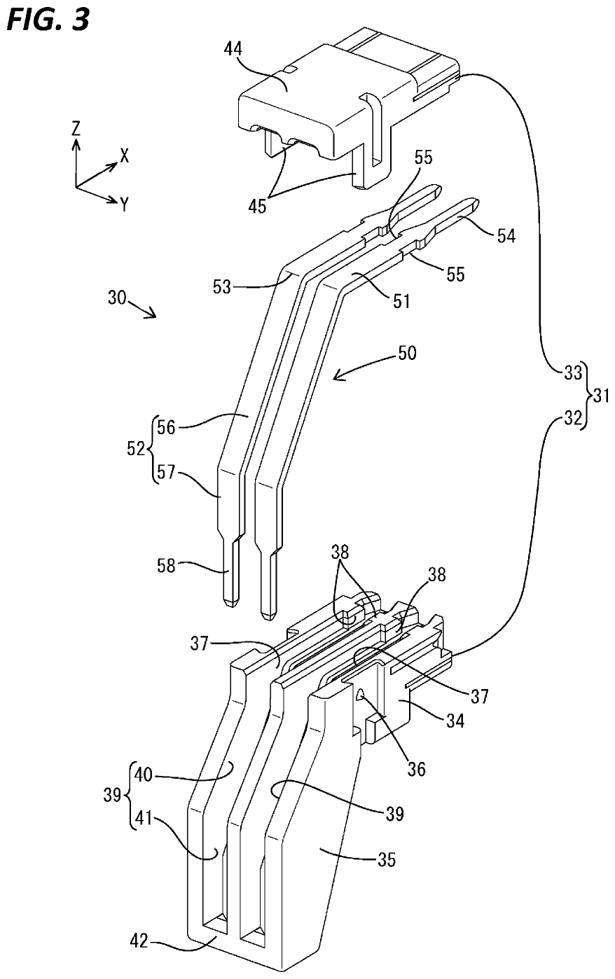

As shown in FIGS. 2 and 3, the large-size terminal module 30 is configured by assembling a large-size dielectric 31, large-size inner conductors 50 and an electrically conductive plate 59. The large-size dielectric 31 is configured by vertically assembling a large-size body member 32 and a large-size cover member 33. The large-size body member 32 is a single component including a terminal receiving portion 34 and a second terminal accommodating portion 35 shaped to extend downward from the rear end of the terminal receiving portion 34. A pair of lock projections 36 are formed on both left and right outer side surfaces of the terminal receiving portion 34.

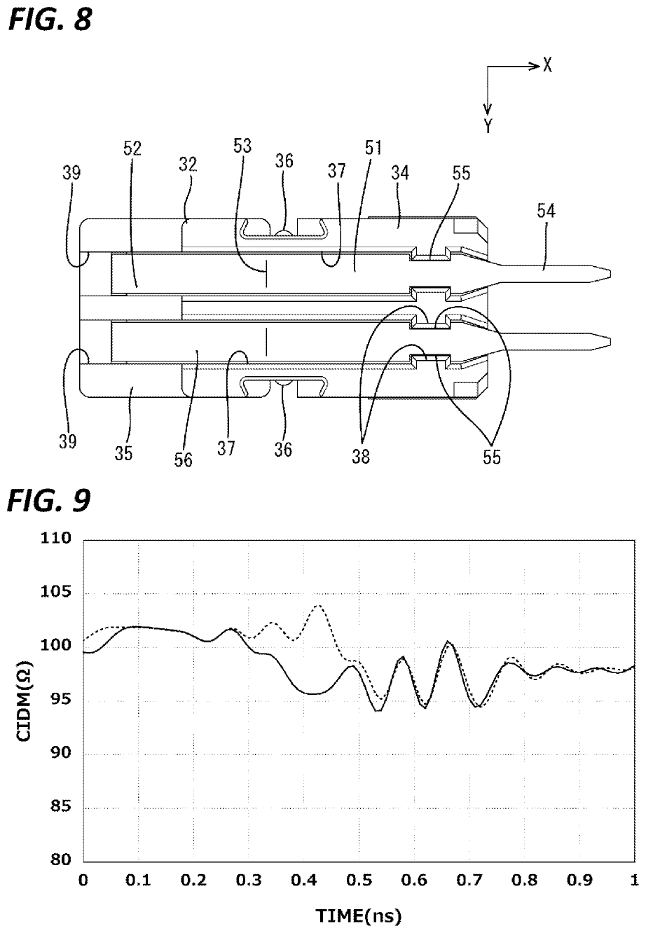

A pair of left and right first accommodation grooves 37 extending in the front-rear direction are formed in the upper surface of the terminal receiving portion 34. The groove bottom surface of the first accommodation groove 37 extends in the front-rear direction. The front end of the first accommodation groove 37 is open in the front end of the terminal receiving portion 34, and the rear end thereof is open in the rear surface of the terminal receiving portion 34. The first accommodation groove 37 is open upward over an entire length. As shown in FIGS. 3 and 8, a pair of fitting portions 38 projecting from both left and right inner side surfaces of the first accommodation groove 37 are formed in the first accommodation groove 37. In a plan view of the large-size body member 32, the fitting portion 38 has a rectangular shape. The front and rear surfaces of the fitting portion 38 are constituted by flat surfaces orthogonal to the front-rear direction.

As shown in FIGS. 3 and 7, the second terminal accommodating portion 35 is formed with a pair of left and right second accommodation grooves 39 extending in the vertical direction. The second accommodation groove 39 includes an inclined groove portion 40 extending obliquely to a lower rear side from the rear end of the first accommodation groove 37 and a vertical groove portion 41 extending downward from the lower end of the inclined groove portion 40. As shown in FIG. 7, in a side view of the large-size body member 32, the groove bottom surface of the inclined groove portion 40 is connected at an obtuse angle to that of the first accommodation groove 37. The groove bottom surface of the vertical groove portion 41 is at a right angle to that of the first accommodation groove 37 and connected at an obtuse angle to that of the inclined groove portion 40. The second accommodation groove 39 is open upward and rearward. An upward opening direction of the second accommodation groove 39 is the same direction as an opening direction of the first accommodation groove 37.

Lower end parts of the second accommodation grooves 39 are formed with a bottom wall portion 42 partitioning between the insides of the second accommodation grooves 39 and the outside of the large-size body member 32. The bottom wall portion 42 is formed with a pair of left and right positioning portions 43. The positioning portions 43 are in the form of holes penetrating through the bottom wall portion 42 in the vertical direction.

As shown in FIG. 3, the large-size cover member 33 is a single component including a plate-like lid portion 44 and a pair of lock arms 45 extending downward from both left and right side edges of the lid portion 44. The large-size cover member 33 is assembled with the large-size body member 32 to cover the terminal receiving portion 34 from above. With the large-size cover member 33 assembled with the large-size body member 32, the lock arms 45 are locked to the lock projections 36, whereby the large-size cover member 33 and the large-size body member 32 are locked in an assembled state. The lid portion 44 covers openings of the first accommodation grooves 37. A pair of left and right first terminal accommodating portions 46 are configured by the terminal receiving portion 34 and the lid portion 44.

As shown in FIGS. 3 and 7, the large-size inner conductor 50 is a single component made of one elongated metal plate material and formed by bending the metal plate material in the same direction as a plate thickness direction. The large-size inner conductor 50 includes a first connecting portion 51, a second connecting portion 52 and a bent portion 53. The first connecting portion 51 has a shape elongated in the front-rear direction. A narrow tab 54 is formed at a front end part of the first connecting portion 51. As shown in FIGS. 3 and 8, a pair of bilaterally symmetrically cut portions 55 are formed in a central part in the front-rear direction of the first connecting portion 51. The cut portions 55 are shaped by cutting both left and right side edge parts of the first connecting portion 51 and have a rectangular plan view shape. A width of the first connecting portion 51 at the cut portions 55 is smaller than that of a region of the first connecting portion 51 behind the cut portions 55. A region of the first connecting portion 51 between the front ends of the cut portions 55 and the rear end of the tab 54 has a trapezoidal shape having a width reduced toward the front.

The second connecting portion 52 extends downward from the rear end of the first connecting portion 51. The upper end of the second connecting portion 52 and the rear end of the first connecting portion 51 are connected via the bent portion 53. In a side view, a rear end part of the first connecting portion 51 and an upper end part of the second connecting portion 52 are connected at an obtuse angle. The second connecting portion 52 includes a straight inclined portion 56 constituting an upper end section of the second connecting portion 52 and a straight vertical portion 57 constituting a lower end section of the second connecting portion 52. The inclined portion 56 and the first connecting portion 51 are connected at an obtuse angle close to 90°. The vertical portion 57 is connected at an obtuse angle close to 180° to the inclined portion 56. The vertical portion 57 and the first connecting portion 51 are at a right angle. A lower end part of the vertical portion 57 is formed with a narrow board connecting portion 58.

Concerning a width of the large-size inner conductor 50, the entire region of the first connecting portion 51 behind the cut portions 55, the entire region of the inclined portion 56, the bent portion 53 and a region of the vertical portion 57 above the board connecting portion 58 are set to have the same width. Therefore, impedances in these regions are roughly matched.

The electrically conductive plate 59 is a single component formed by bending a metal plate material and functions as the outer conductor 16. As shown in FIG. 2, the electrically conductive plate 59 includes a base plate portion 60 and a pair of side plate portions 61 extending rearward from both left and right side edges of the base plate portion 60. The electrically conductive plate 59 is assembled with the large-size body member 32 by being press-fit from front. The base plate portion 60 is arranged in close contact with the front surface of the second terminal accommodating portion 35, and the side plate portions 61 are arranged in close contact with both left and right outer side surfaces of the second terminal accommodating portion 35.

### (Small-Size Terminal Module 65)

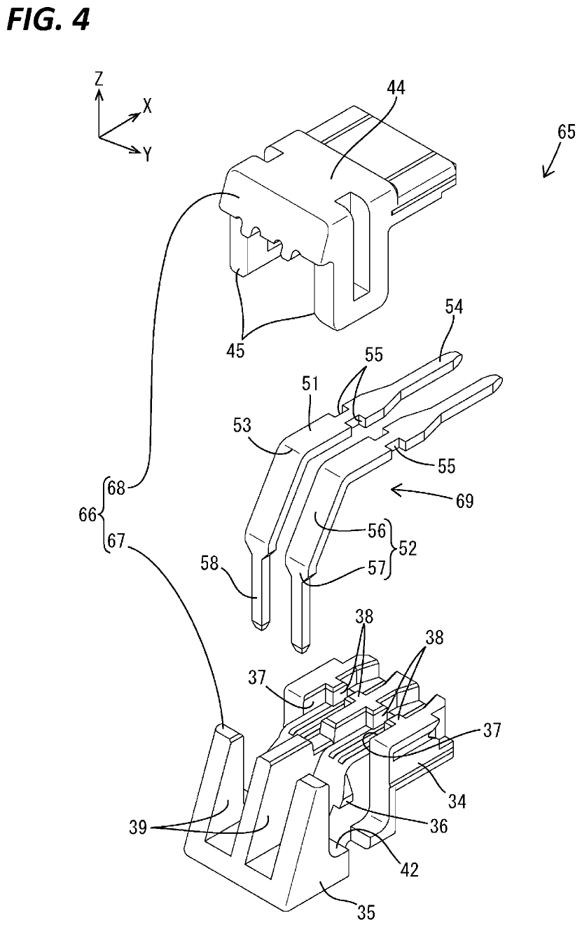

The small-size terminal module 65 is configured by assembling a small-size dielectric 66 and small-size inner conductors 69. As shown in FIGS. 2 and 4, the small-size dielectric 66 is configured by vertically assembling a small-size body member 67 and a small-size cover member 68. The small-size body member 67 is a single component including a terminal receiving portion 34 and a second terminal accommodating portion 35 shaped to project downward from the rear end of the terminal receiving portion 34. A pair of lock projections 36 are formed on both left and right outer side surfaces of the terminal receiving portion 34.

A pair of left and right first accommodation grooves 37 extending in the front-rear direction are formed in the upper surface of the terminal receiving portion 34. The groove bottom surface of the first accommodation groove 37 extends in the front-rear direction. The front end of the first accommodation groove 37 is open in the front end of the terminal receiving portion 34, and the rear end thereof is open in the rear surface of the terminal receiving portion 34. The first accommodation groove 37 is open upward over an entire length. A pair of fitting portions 38 projecting from both left and right inner side surfaces of the first accommodation groove 37 are formed in the first accommodation groove 37. In a plan view of the large-size body member 32, the fitting portion 38 has a rectangular shape. The front and rear surfaces of the fitting portion 38 are constituted by flat surfaces orthogonal to the front-rear direction.

The second terminal accommodating portion 35 is formed with a pair of left and right second accommodation grooves 39 extending in the vertical direction. As shown in FIG. 7, the second accommodation groove 39 includes an inclined groove portion 40 extending obliquely to a lower rear side from the rear end of the first accommodation groove 37 and a vertical groove portion 41 extending downward from the lower end of the inclined groove portion 40. In a side view of the large-size body member 32, the groove bottom surface of the inclined groove portion 40 is connected at an obtuse angle to that of the first accommodation groove 37. The groove bottom surface of the vertical groove portion 41 is at a right angle to that of the first accommodation groove 37 and connected at an obtuse angle to that of the inclined groove portion 40. The second accommodation groove 39 is open upward and rearward. An upward opening direction of the second accommodation groove 39 is the same direction as an opening direction of the first accommodation groove 37.

Lower end parts of the second accommodation grooves 39 are formed with a bottom wall portion 42 partitioning between the insides of the second accommodation grooves 39 and the outside of the small-size body member 67. The bottom wall portion 42 is formed with a pair of left and right positioning portions 43. The positioning portions 43 are in the form of holes penetrating through the bottom wall portion 42 in the vertical direction.

The small-size cover member 68 is a single component including a plate-like lid portion 44 and a pair of lock arms 45 extending downward from both left and right side edges of the lid portion 44. The small-size cover member 68 is assembled with the small-size body member 67 to cover the terminal receiving portion 34 from above. With the small-size cover member 68 assembled with the small-size body member 67, the lock arms 45 are locked to the lock projections 36, whereby the small-size cover member 68 and the small-size body member 67 are locked in an assembled state. The lid portion 44 covers openings of the first accommodation grooves 37. A pair of left and right first terminal accommodating portions 46 are configured by the terminal receiving portion 34 and the lid portion 44.

As shown in FIGS. 4 and 7, the small-size inner conductor 69 is a single component made of one elongated metal plate material and formed by bending the metal plate material in the same direction as a plate thickness direction. The small-size inner conductor 69 includes a first connecting portion 51, a second connecting portion 52 and a bent portion 53. The first connecting portion 51 has a shape elongated in the front-rear direction. A narrow tab 54 is formed at a front end part of the first connecting portion 51. A pair of bilaterally symmetrically cut portions 55 are formed in a part closer to a rear end side than a center in the front-rear direction of the first connecting portion 51. The cut portions 55 are shaped by cutting both left and right side edge parts of the first connecting portion 51 and have a rectangular plan view shape. A width of the first connecting portion 51 at the cut portions 55 is smaller than that of a region of the first connecting portion 51 behind the cut portions 55. A region of the first connecting portion 51 between the front ends of the cut portions 55 and the rear end of the tab 54 has a trapezoidal shape having a width reduced toward the front.

The second connecting portion 52 extends downward from the rear end of the first connecting portion 51. An upper end part of the second connecting portion 52 and a rear end part of the first connecting portion 51 are connected via the bent portion 53. In a side view, the rear end part of the first connecting portion 51 and the upper end part of the second connecting portion 52 are connected at an obtuse angle. The second connecting portion 52 includes a straight inclined portion 56 constituting an upper end section of the second connecting portion 52 and a straight vertical portion 57 constituting a lower end section of the second connecting portion 52. The inclined portion 56 and the first connecting portion 51 are connected at an obtuse angle close to 90°. The vertical portion 57 is connected at an obtuse angle close to 180° to the inclined portion 56. The vertical portion 57 and the first connecting portion 51 are at a right angle. A region of the vertical portion 57 except an upper end part is formed with a narrow board connecting portion 58.

Concerning a width of the small-size inner conductor 69, the entire region of the first connecting portion 51 behind the cut portions 55, the entire region of the inclined portion 56, the bent portion 53 and a region of the vertical portion 57 above the board connecting portion 58 are set to have the same width. Therefore, impedances in these regions are roughly matched.

### Functions and Effects of First Embodiment

An assembly procedure of the large-size terminal module 30 is described. With the large-size cover member 33 removed from the large-size body member 32, the large-size inner conductors 30 are temporarily assembled with the large-size body member 32 from above. At this time, the first connecting portion 51 of the large-size inner conductor 50 is fit into the first accommodation groove 37, the second connecting portion 52 is fit into the second accommodation groove 39, and the board connecting portion 58 of the second connecting portion 52 is inserted into the positioning portion 43. Since the second accommodation groove 39 extends in a direction intersecting the first accommodation groove 37, but is open not only rearward, but also upward like the first accommodation groove 37, there is no problem in assembling the second connecting portion 52. In the second accommodation groove 39, the entire inclined portion 56 is accommodated in the inclined groove portion 40 and a part of the vertical portion 57 above the board connecting portion 58 is accommodated in the vertical groove portion 41.

After the large-size inner conductors 50 are assembled with the large-size body member 32, the large-size cover member 33 is assembled with the large-size body member 32. The large-size cover member 33 and the large-size body member 32 are held in the assembled state by locking the lock arms 45 and the lock projections 36. In this way, the large-size inner conductors 50 and the large-size dielectric 31 are integrated at the same time as the assembly of the large-size dielectric 31 is completed. Before or after the assembly of the large-size inner conductors 50 and the large-size dielectric 31, the electrically conductive plate 59 is assembled with the large-size body member 32. In the above way, the assembly of the large-size terminal module 30 is completed.

The lid portion 44 of the large-size cover member 33 closes the upper surface openings of the first accommodation grooves 37, whereby the first terminal accommodating portions 46 are configured. The first accommodation groove 51 is accommodated in the first terminal accommodating portion 46. Upward separation of the first connecting portion 51 is restricted by the lid portion 44. Relative movements of the large-size inner conductor 50 (first connecting portion 51) in the front-rear direction and lateral direction with respect to the large-size dielectric 31 are restricted by fitting the cut portions 55 and the fitting portions 38. The tab 54 projects forward from the first terminal accommodating portion 46. The board connecting portion 58 is positioned in the front-rear direction and lateral direction by being fit into the positioning portion 43. The board connecting portion 58 projects downward from the lower end surface of the second terminal accommodating portion 35 and becomes connectable to a circuit board (not shown).

Next, an assembly procedure of the small-size terminal module 65 is described. With the small-size cover member 68 removed from the small-size body member 67, the small-size inner conductors 69 are temporarily assembled with the small-size body member 67 from above. At this time, the first connecting portion 51 of the small-size inner conductor 69 is fit into the first accommodation groove 37, the second connecting portion 52 is fit into the second accommodation groove 39, and the board connecting portion 58 of the second connecting portion 52 is inserted into the positioning portion 43. Since the second accommodation groove 39 extends in a direction intersecting the first accommodation groove 37, but is open not only rearward, but also upward like the first accommodation groove 37, there is no problem in assembling the second connecting portion 52. In the second accommodation groove 39, the entire inclined portion 56 is accommodated in the inclined groove portion 40 and a part of the vertical portion 57 above the board connecting portion 58 is accommodated in the vertical groove portion 41.

After the small-size inner conductors 69 are assembled with the small-size body member 67, the small-size cover member 68 is assembled with the small-size body member 67. The small-size cover member 68 and the small-size body member 67 are held in the assembled state by locking the lock arms 45 and the lock projections 36. In this way, the small-size inner conductors and the small-size dielectric 66 are integrated at the same time as the assembly of the small-size dielectric 66 is completed. In the above way, the assembly of the small-size terminal module 65 is completed.

The lid portion 44 of the small-size cover member 68 closes the upper surface openings of the first accommodation grooves 37, whereby the first terminal accommodating portions 46 are configured. The first accommodation groove 51 is accommodated in the first terminal accommodating portion 46. Upward separation of the first connecting portion 51 is restricted by the lid portion 44. Relative movements of the small-size inner conductor 69 (first connecting portion 51) in the front-rear direction and lateral direction with respect to the small-size dielectric 66 are restricted by fitting the cut portions 55 and the fitting portions 38. The tab 54 projects forward from the first terminal accommodating portion 46. The board connecting portion 58 is positioned in the front-rear direction and lateral direction by being fit into the positioning portion 43. The board connecting portion 58 projects downward from the lower end surface of the second terminal accommodating portion 35 and becomes connectable to the circuit board (not shown).

After the assembly of the large-size terminal modules 30 and that of the small-size terminal modules 65 are completed, the both terminal modules 30, 65 are assembled with the outer conductor 16. In assembling, the first terminal accommodating portions 46 of the small-size terminal modules 65 are first inserted into the accommodation spaces 20 from behind the outer conductor 16 and fit into the connection ports 18 in the lower stage. The tabs 54 projecting from the first terminal accommodating portions 46 are accommodated in the connection ports 18. The second terminal accommodating portions 35 are accommodated in the accommodation spaces 20. Subsequently, the first terminal accommodating portions 46 of the large-size terminal modules 30 are inserted in the accommodation spaces 20 from behind the outer conductor 16 and fit into the connection ports 18 in the upper stage. The tabs 54 projecting from the first terminal accommodating portions 46 are accommodated in the connection ports 18. The second terminal accommodating portions 35 are accommodated in the accommodation space 20. In the above way, the assembly of the shield terminal 15 is completed.

Before or after the assembly of the both terminal modules 30, 65 and the outer conductor 16, the outer conductor 16 and the receptacle member 10 are assembled. In assembling, each connection port 18 is fit into the through hole 13 of the receptacle member 10 and the front surface of the box-shaped body portion 17 is held in close contact with the rear surface of the base portion 11 of the receptacle member 10. In the above way, the assembly of the shield connector 1 is completed.

### Functions and Effects of First Embodiment

The shield connector 1 of the first embodiment is provided with the large-size inner conductors 50, the large-size dielectrics 31, the outer conductor 16, the small-size inner conductors 69 and the small-size dielectrics 66. Each of the large-size inner conductors 50 and the small-size inner conductors 69 is formed by bending the elongated metal plate in the plate thickness direction and includes the first connecting portion 51 and the second connecting portion 52 extending from the bent portion 53 in directions different from each other. The large-size inner conductors 50 are mounted into the large-size dielectrics 31, and the small-size inner conductors 69 are mounted into the small-size dielectrics 66. The outer conductor 16 exhibits a shielding function by surrounding the large-size dielectrics 31 and the small-size dielectrics 66.

Each of the large-size dielectric 31 and the small-size dielectric 66 includes the first terminal accommodating portions 46 and the second terminal accommodating portion 35. The first terminal accommodating portions 46 surround the first connecting portions 51 over the entire periphery. The second terminal accommodating portion 35 accommodates the second connecting portions 52. The first terminal accommodating portions 46 of the large-size dielectric 31 are provided with the large-size body member 32 and the large-size cover member 33. The large-size body member 32 is integrally molded with the second terminal accommodating portion 35. The large-size cover member 33 is assembled with the large-size body member 32 in a direction intersecting a longitudinal direction of the first connecting portions 51. The first terminal accommodating portions 46 of the small-size dielectric 66 are provided with the small-size body member 67 and the small-size cover member 68. The small-size body member 67 is integrally molded with the second terminal accommodating portion 35. The small-size cover member 68 is assembled with the small-size body member 67 in a direction intersecting a longitudinal direction of the first connecting portions 51.

In assembling the large-size inner conductor 50 with the large-size dielectric 31, the first connecting portion 51 can be accommodated into the first terminal accommodating portion 46 without pressing the large-size inner conductor 50 in the plate thickness direction. It is not necessary to form a step portion for pressing the large-size inner conductor 50 in the plate thickness direction at the bent portion 53 or in a part near the bent portion 53 in the large-size inner conductor 50. Therefore, it can be realized that a region of the large-size inner conductor 50 where the first connecting portion 51, the bent portion 53 and the second connecting portion 52 are connected is set to have a constant width. In this way, an impedance mismatch in the bent portion 53 of the large-size inner conductor 50 can be suppressed.

The assembly of the small-size inner conductor 69 with the small-size dielectric 66 is also performed in the same procedure as the assembly of the large-size inner conductor 50 with the large-size dielectric 31. It is not necessary to form a step portion for pressing the small-size inner conductor 69 in the plate thickness direction at the bent portion 53 or in a part near the bent portion 53 in the small-size inner conductor 69. Therefore, it can be realized that a region of the small-size inner conductor 69 where the first connecting portion 51, the bent portion 53 and the second connecting portion 52 are connected is set to have a constant width. In this way, an impedance mismatch in the bent portion 53 of the small-size inner conductor 69 can be suppressed.

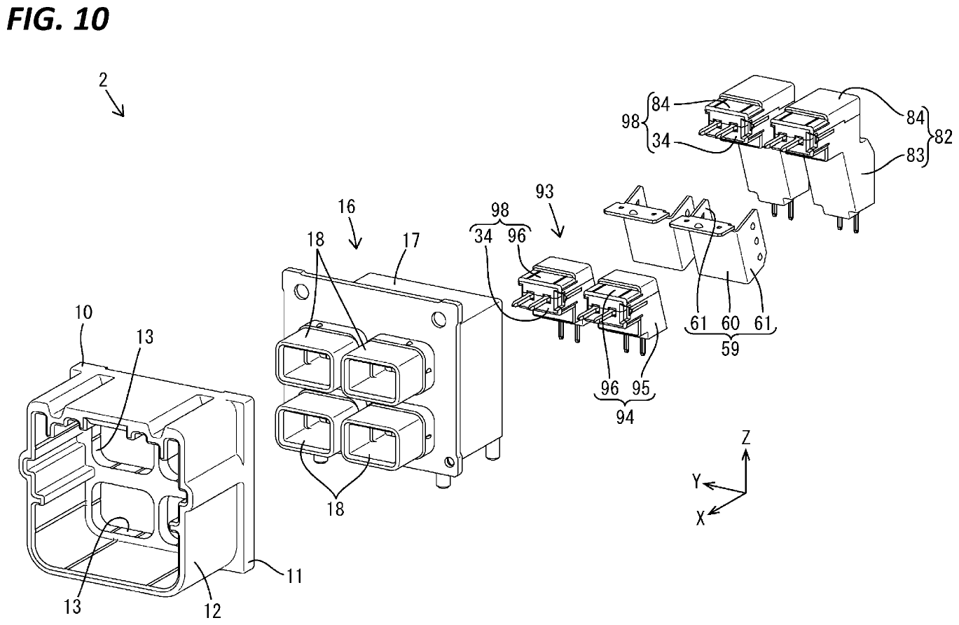

A graph shown in FIG. 9 shows a comparison of a characteristic impedance in the large-size inner conductor 50 of the first embodiment and a characteristic impedance of an inner conductor (not shown) to be compered and having a shape different from that of the first embodiment. In FIG. 9, a solid line represents the characteristic impedance of the large-size inner conductor 50, and a broken line presents the characteristic impedance of the inner conductor to be compared. The basic shape and dimensions of the inner conductor to be compared are the same as those of the large-size inner conductor 50 of the first embodiment. The both inner conductors differ in that the first connecting portion 51 is formed with the cut portions 55 in the large-size inner conductor 50, whereas the inner conductor to be compared is not formed with the cut portions 55. Further, the rear end part of the first connecting portion 51, the bent portion 53 and the upper end part of the second connecting portion 52 in the large-size inner conductor 50 have a constant width. In contrast, in the inner conductor to be compared, both left and right side edge parts of a rear end part of a first connecting portion, a bent portion and an upper end part of a second connecting portion are cut into a step shape, and the first connecting portion 51 is pushed from behind. As shown in FIG. 9, a variation range of the characteristic impedance of the large-size inner conductor 50 is suppressed to be smaller than that of the characteristic impedance of the inner conductor to be compared. Thus, the communication performance of the large-size inner conductor 50 is more stable and better than that of the inner conductor to be compared.

The first terminal accommodating portion 46 and the first connecting portion 51 are formed with a holding portion. The holding portion restricts a relative displacement of the first connecting portion 51 in the longitudinal direction (front-rear direction) of the first connecting portion 51 with respect to the first terminal accommodating portion 46. The holding portion is provided with the cut portions 55 shaped by cutting the side edge parts of the first connecting portion 51 and the fitting portions 38 formed in the first terminal accommodating portion 46. The cut portions 55 are fit to the fitting portions 38. By the locking action of the cut portions 55 and the fitting portions 38, the large-size inner conductor 50 can be reliably held positioned with respect to the large-size dielectric 31 and the small-size inner conductor 69 can be reliably held positioned with respect to the small-size dielectric 66.

Each of the large-size body member 32 and the small-size body member 67 is formed with the first accommodation grooves 37 for accommodating the first connecting portions 51. The first accommodation groove 37 is open in a direction (upward) opposite to an extending direction (downward) of the second connecting portion 52. The second terminal accommodating portion 35 is formed with the positioning portions 43 for positioning the board connecting portions 58 (extending end parts) of the second connecting portions 52. In the process of accommodating the first connecting portion 51 into the first accommodation groove 37, the board connecting portion 58 of the second connecting portion 52 can be positioned by the positioning portion 43. Since the positioning portion 43 is in the shape of a hole for allowing the passage of the board connecting portion 58 therethrough, the board connecting portion 58 can be positioned in two-dimensional directions (front-rear direction and lateral direction).

The first and second connecting portions 51, 52 extend from the bent portion 53 in directions at an obtuse angle to each other. According to this configuration, when the positions of the extending end (front end) of the first connecting portion 51 and the extending end (lower end) of the second connecting portion 52 are fixed, the entire lengths of the large-size inner conductor 50 and the small-size inner conductor 69 can be shortened as compared to the case where the first and second connecting portions 51, 52 extend in directions at a right angle to each other. In the bent portion 53 of the large-size inner conductor 50 and the bent portion 53 of the small-size inner conductor 69, an impedance is lower than in the first and second connecting portions 51, 52. However, since the bent portion 53 connects the first and second connecting portions 51, 52 at an obtuse angle, an impedance reduction is suppressed as compared to the case where the both connecting portions 51, 52 are connected at a right angle. In this way, an impedance mismatch between the both connecting portions 51, 52 and the bent portion 53 can be suppressed to be small.

The second terminal accommodating portion 35 is in the form of grooves extending along a longitudinal direction (vertical direction) of the second connecting portions 52 and open in a direction (rearward) opposite to an extending direction of the first connecting portions 51. According to this configuration, in the process of assembling the first connecting portion 51 with the large-size body member 32 or the small-size body member 67 while moving the first connecting portion in the plate thickness direction thereof, the second connecting portion 52 can be accommodated into the second terminal accommodating portion 35. Thus, the second terminal accommodating portion 35 needs not be constituted by two members and is realized as a single component.

### Second Embodiment

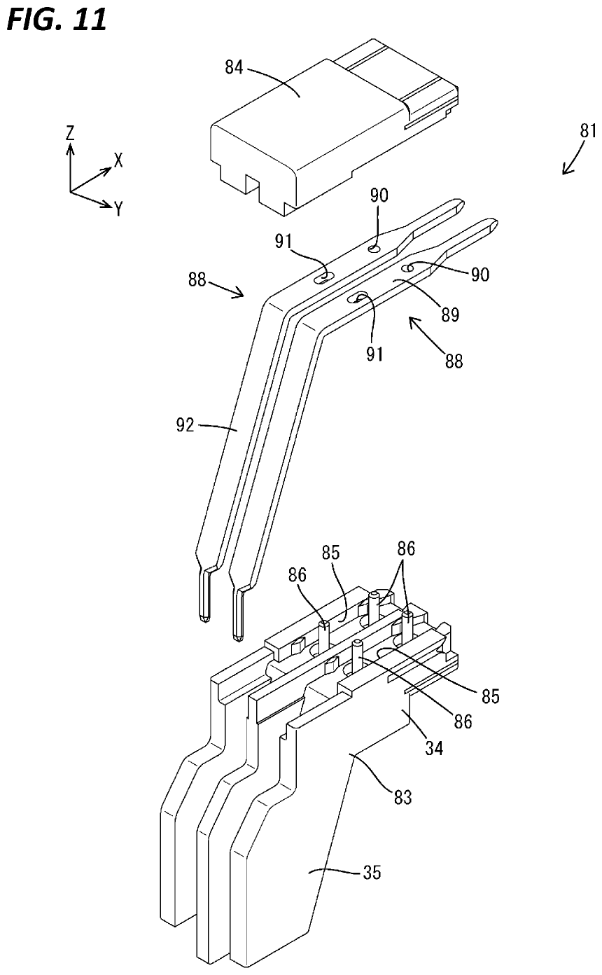

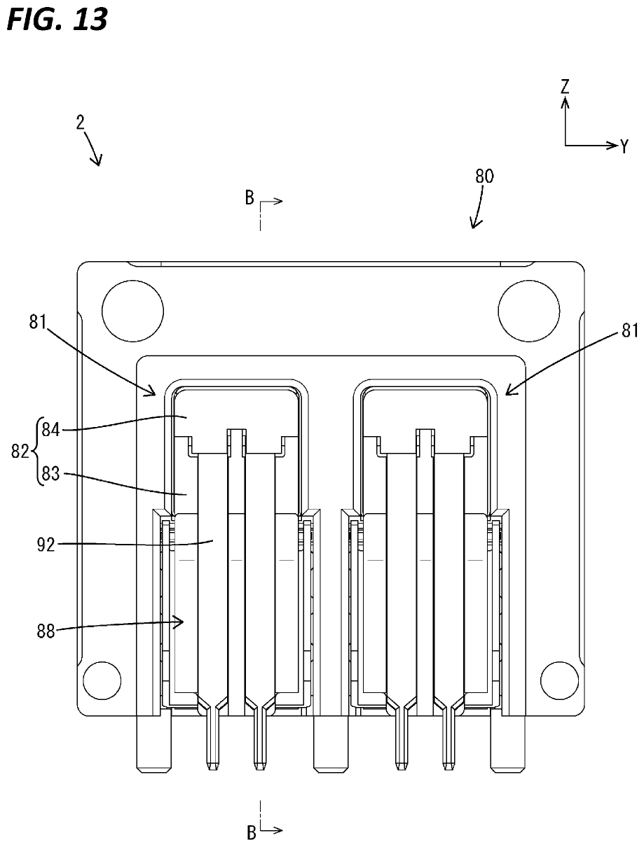

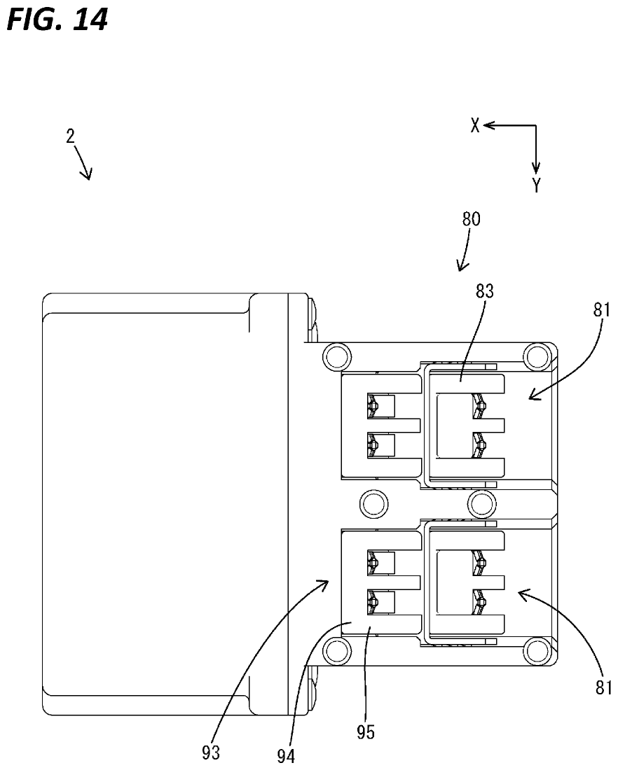

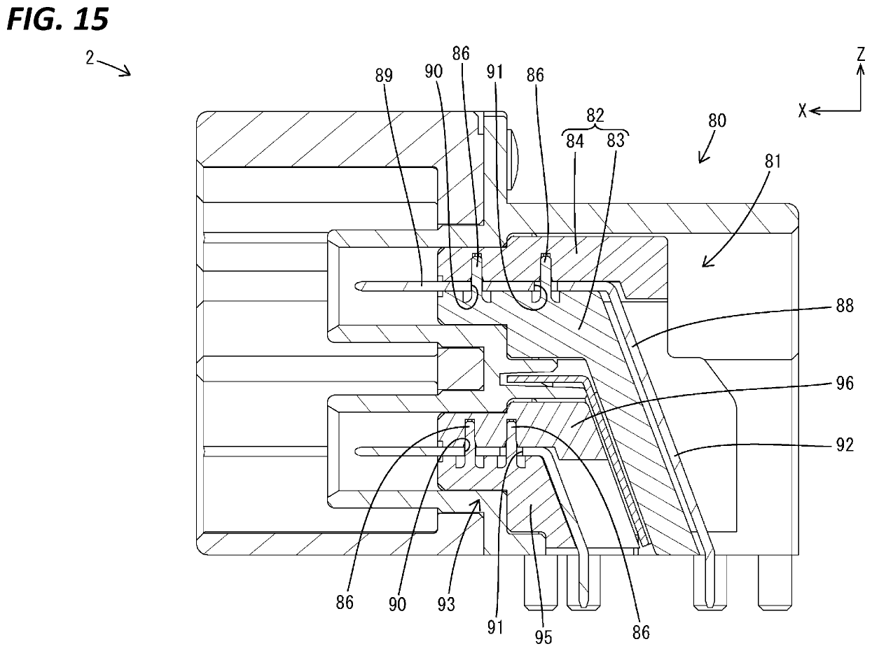

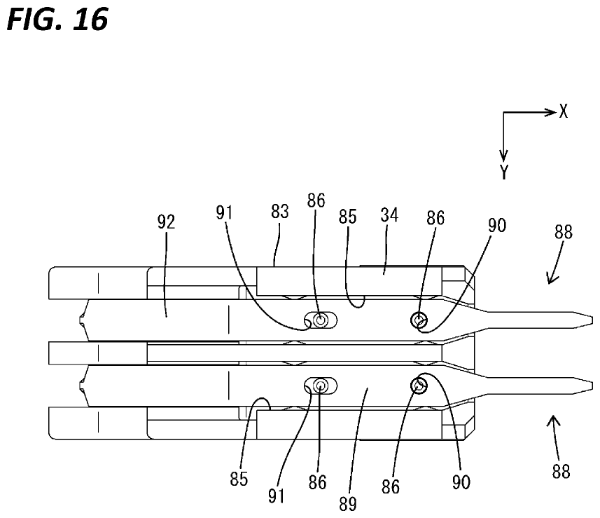

A second specific embodiment of the present disclosure is described with reference to FIGS. 10 to 16. A shield connector 2 of the second embodiment differs from the first embodiment in the configuration of a holding portion for holding a large-size inner conductor 88 in a large-size dielectric 82 and the configuration of a holding portion for holding a small-size inner conductor 97 in a small-size dielectric 94. Second terminal accommodating portions 35 of the shield connector 2 of the second embodiment include no positioning portions for positioning extending end parts of the large-size inner conductors 88 and the small-size inner conductors 97. Since the other configuration is the same as in the first embodiment, the same components and parts are denoted by the same reference signs and the structures, functions and effects thereof are not described.

In the second embodiment, a positive direction along an X axis in FIGS. 10 to 12 and 14 to 16 is defined as a forward direction concerning a front-rear direction. A positive direction along a Y axis in FIGS. 10 to 14 and 16 is defined as a rightward direction concerning a lateral direction. A positive direction along a Z axis in FIGS. 10 to 13 and 15 is defined as an upward direction concerning a vertical direction.

The shield connector 2 of the second embodiment is configured by assembling the same receptacle member 10 as in the first embodiment and one shield terminal 80. The shield terminal 80 is configured by assembling the same outer conductor 16 as in the first embodiment, a pair of large-size terminal modules 81 arranged in the lateral direction and a pair of small-size terminal modules 93 arranged in the lateral direction.

The large-size terminal module 81 is configured by assembling the large-size dielectric 82, the large-size inner conductors 88 and the same electrically conductive plate 59 as in the first embodiment. A basic structure of the large-size dielectric 82 is the same as that of the large-size dielectric 31 of the first embodiment. The large-size dielectric 82 is configured by vertically assembling a large-size body member 83 and a large-size cover member 84. The large-size body member 83 is a single component including a terminal receiving portion 34 and a second terminal accommodating portion 35 shaped to extend downward from the rear end of the terminal receiving portion 34.

As shown in FIG. 11, a pair of left and right first accommodation grooves 85 extending in the front-rear direction are formed in the upper surface of the terminal receiving portion 34. The groove bottom surface of the first accommodation groove 85 extends in the front-rear direction. The front end of the first accommodation groove 85 is open in the front end of the terminal receiving portion 34, and the rear end thereof is open in the rear surface of the terminal receiving portion 34. The first accommodation groove 85 is open upward over an entire length. The first accommodation groove 85 is formed with a pair of locking protrusions 86 projecting upward from the groove bottom surface. The pair of locking protrusions 86 are arranged apart in the front-rear direction. Each locking protrusion 86 has a cylindrical shape having a circular plan view shape.

The large-size inner conductor 88 has the same basic shape as the large-size inner conductor 88 of the first embodiment. A first connecting portion 89 of the large-size inner conductor 88 is formed with a positioning lock hole 90 and a tolerance absorbing lock hole 91 spaced apart in the front-rear direction. The positioning lock hole 90 has a circular plan view shape. An inner diameter of the positioning lock hole 90 is equal to an outer diameter of the locking protrusion 86. The tolerance absorbing lock hole 91 has an elliptical plan view shape long in the front-rear direction. A width in the lateral direction of the tolerance absorbing lock hole 91 is equal to the outer diameter of the locking protrusion 86. A length in the front-rear direction of the tolerance absorbing lock hole 91 is larger than the outer diameter of the locking protrusion 86. A second connecting portion 92 extends obliquely to a lower rear side from the rear end of the first connecting portion 89.

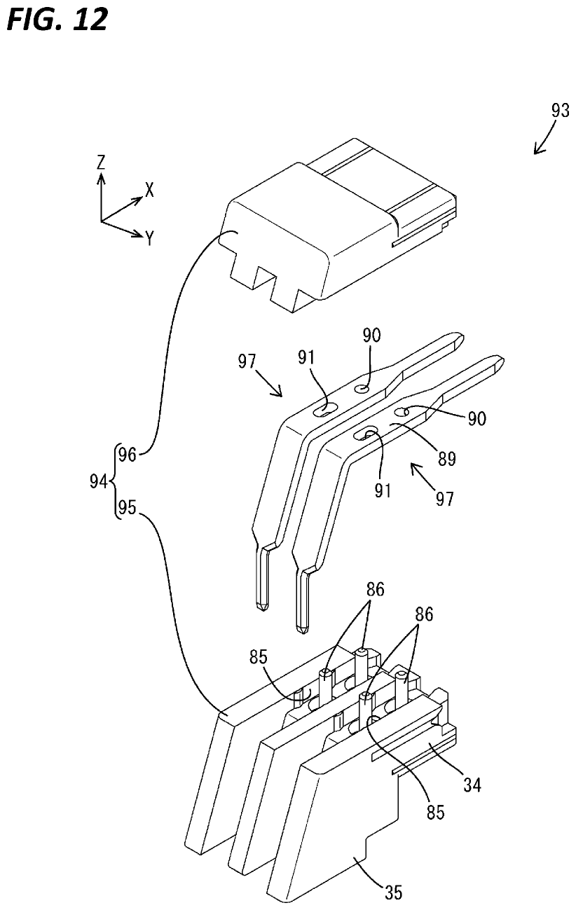

As shown in FIG. 12, the small-size terminal module 93 is configured by assembling the small-size dielectric 94 and the small-size inner conductors 97. A basic structure of the small-size dielectric 94 is the same as that of the small-size dielectric 66 of the first embodiment. The small-size dielectric 94 is configured by vertically assembling a small-size body member 95 and a small-size cover member 96. The small-size body member 95 is a single component including a terminal receiving portion 34 and a second terminal accommodating portion 35 shaped to extend downward from the rear end of the terminal receiving portion 34.

A pair of left and right first accommodation grooves 85 extending in the front-rear direction are formed in the upper surface of the terminal receiving portion 34. The groove bottom surface of the first accommodation groove 85 extends in the front-rear direction. The front end of the first accommodation groove 85 is open in the front end of the terminal receiving portion 34, and the rear end thereof is open in the rear surface of the terminal receiving portion 34. The first accommodation groove 85 is open upward over an entire length. The first accommodation groove 85 is formed with a pair of locking protrusions 86 projecting upward from the groove bottom surface. The pair of locking protrusions 86 are arranged apart in the front-rear direction. Each locking protrusion 86 has a cylindrical shape having a circular plan view shape.

The small-size inner conductor 97 has the same basic shape as the small-size inner conductor 69 of the first embodiment. A first connecting portion 89 of the small-size inner conductor 97 is formed with a positioning lock hole 90 and a tolerance absorbing lock hole 91 spaced apart in the front-rear direction. The positioning lock hole 90 has a circular plan view shape. An inner diameter of the positioning lock hole 90 is equal to an outer diameter of the locking protrusion 86. The tolerance absorbing lock hole 91 has an elliptical plan view shape long in the front-rear direction. A width in the lateral direction of the tolerance absorbing lock hole 91 is equal to the outer diameter of the locking protrusion 86. A length in the front-rear direction of the tolerance absorbing lock hole 91 is larger than the outer diameter of the locking protrusion 86.

First terminal accommodating portions 98 of the large-size terminal module 81 is configured by assembling the terminal receiving portion 34 and the large-size cover member 84. First terminal accommodating portions 98 of the small-size terminal module 93 are configured by assembling the terminal receiving portion 34 and the small-size cover member 96. The first terminal accommodating portion 98 and the first connecting portion 89 are formed with a holding portion. The holding portion restricts a relative displacement of the first connecting portion 89 in a longitudinal direction of the first connecting portion 89 with respect to the first terminal accommodating portion 98. The holding portion is provided with the lock holes 90, 91 formed in the first connecting portion 89 and the locking protrusions 86 formed in the first terminal accommodating portion 98 and to be accommodated into the lock holes 90, 91. According to this configuration, the inner conductor 88, 97 can be held positioned with respect to the dielectric 82, 94 by the locking action of the lock holes 90, 91 and the locking protrusions 86.

The lock holes 90, 91 include the circular positioning lock hole 90 and the elliptical tolerance absorbing lock hole 91 spaced apart in the longitudinal direction of the first connecting portion 89. Out of the two circular locking protrusions 86, one (front) locking protrusion 86 is fit into the positioning lock hole 90 with relative displacements in two-dimensional directions (front-rear direction and lateral direction) restricted. Out of the two circular locking protrusions 86, the other (rear) locking protrusion 86 is fit into the tolerance absorbing lock hole 91 with a relative displacement in one direction (lateral direction) restricted. Even if an interval between the two locking protrusions 86 varies, such a variation can be absorbed by the tolerance absorbing lock hole 91.

### Other Embodiments

The present invention is not limited to the above described and illustrated embodiments, but is represented by claims. The present invention includes all changes in the scope of claims and in the meaning and scope of equivalents and also includes the following embodiments.

In the first and second embodiments, the first and second connecting portions may extend in directions at a right angle to each other.

In the first and second embodiments, the second terminal accommodating portion may be configured by assembling a plurality of members.

In the first embodiment, the first connecting portion may be formed with lock holes.

In the second embodiment, cut portions may be formed in side edge parts of the first connecting portion.

In the second embodiment, all the lock holes may have a circular shape.

### LIST OF REFERENCE NUMERALS

1 . . . shield connector
2 . . . shield connector
10 . . . receptacle member
11 . . . base portion
12 . . . tubular connecting portion
13 . . . through hole
15 . . . shield terminal
16 . . . outer conductor
17 . . . box-shaped body portion
18 . . . connection port
19 . . . partition wall
20 . . . accommodation space
30 . . . large-size terminal module
31 . . . large-size dielectric (dielectric)
32 . . . large-size body member (body member)
33 . . . large-size cover member (cover member)
34 . . . terminal receiving portion
35 . . . second terminal accommodating portion
36 . . . lock projection
37 . . . first accommodation groove (accommodation groove)
38 . . . fitting portion (holding portion)
39 . . . second accommodation groove
40 . . . inclined groove portion
41 . . . vertical groove portion
42 . . . bottom wall portion
43 . . . positioning portion
44 . . . lid portion
45 . . . lock arm
46 . . . first terminal accommodating portion
50 . . . large-size inner conductor (inner conductor)
51 . . . first connecting portion
52 . . . second connecting portion
53 . . . bent portion
54 . . . tab
55 . . . cut portion (holding portion)
56 . . . inclined portion
57 . . . vertical portion
58 . . . board connecting portion
59 . . . electrically conductive plate
60 . . . base plate portion
61 . . . side plate portion
65 . . . small-size terminal module
66 . . . small-size dielectric (dielectric)
67 . . . small-size body member (body member)
68 . . . small-size cover member (cover member)
69 . . . small-size inner conductor (inner conductor)
80 . . . shield terminal
81 . . . large-size terminal module
82 . . . large-size dielectric (dielectric)
83 . . . large-size body member (body member)
84 . . . large-size cover member (cover member)
85 . . . first accommodation groove (accommodation groove)
86 . . . locking protrusion
88 . . . large-size inner conductor (inner conductor)
89 . . . first connecting portion
90 . . . positioning lock hole (holding portion, lock hole)
91 . . . tolerance absorbing lock hole (holding portion, lock hole)
92 . . . second connecting portion
93 . . . small-size terminal module
94 . . . small-size dielectric (dielectric)
95 . . . small-size body member (body member)
96 . . . small-size cover member (cover member)
97 . . . small-size inner conductor (inner conductor)
98 . . . first terminal accommodating portion

1. A shield connector, comprising:
an inner conductor shaped by bending an elongated metal plate material in a plate thickness direction, the inner conductor including a first connecting portion and a second connecting portion extending from a bent portion in directions different from each other;
a dielectric to be mounted with the inner conductor; and
an outer conductor for surrounding the dielectric,
the dielectric including a first terminal accommodating portion for surrounding and accommodating the first connecting portion over an entire periphery and a second terminal accommodating portion for accommodating the second connecting portion, and
the first terminal accommodating portion including a body member integrally molded with the second terminal accommodating portion and a cover member to be assembled with the body member in a direction intersecting a longitudinal direction of the first connecting portion.

2. The shield connector of claim 1, wherein the first terminal accommodating portion and the first connecting portion are formed with a holding portion for restricting a relative displacement of the first connecting portion in the longitudinal direction of the first connecting portion with respect to the first terminal accommodating portion.

3. The shield connector of claim 2, wherein the holding portion includes a cut portion shaped by cutting a side edge part of the first connecting portion and a fitting portion formed in the first terminal accommodating portion, the cut portion being fit to the fitting portion.

4. The shield connector of claim 2, wherein the holding portion includes a lock hole formed in the first connecting portion and a locking protrusion formed in the first terminal accommodating portion, the locking protrusion being accommodated into the lock hole.

5. The shield connector of claim 4, wherein:
the lock holes include a circular positioning lock hole and an elliptical tolerance absorbing lock hole spaced apart in the longitudinal direction of the first connecting portion,
one locking protrusion, out of two circular locking protrusions, is fit into the positioning lock hole with relative displacements in two-dimensional directions restricted, and
the other locking protrusion, out of the two circular locking protrusions, is fit into the tolerance absorbing lock hole with a relative displacement in one direction restricted.

6. The shield connector of claim 1, wherein:
the body member is formed with an accommodation groove open in a direction opposite to an extending direction of the second connecting portion, the accommodation groove accommodating the first connecting portion, and
the second terminal accommodating portion is formed with a positioning portion for positioning an extending end part of the second connecting portion.

7. The shield connector of claim 6, wherein the positioning portion is in the shape of a hole for allowing passage of the extending end part of the second connecting portion therethrough.

8. The shield connector of claim 1, wherein the first and second connecting portions extend in directions at an obtuse angle to each other.

9. The shield connector of claim 8, wherein the second terminal accommodating portion is in the form of a groove extending along a longitudinal direction of the second connecting portion and open in a direction opposite to an extending direction of the first connecting portion.
